(19) United States
(12) Patent Application Publication
(10) Pub. No.: US 2024/0094867 A1
(43) Pub. Date: Mar. 21, 2024

(54) CLUSTER ICON VALIDATION

(71) Applicant: Garmin International, Inc., Olathe, KS (US)

(72) Inventor: Alexandre S. Relange, Hallbergmoos (DE)

(21) Appl. No.: 18/448,266

(22) Filed: Aug. 11, 2023

Related U.S. Application Data
(60) Provisional application No. 63/407,965, filed on Sep. 19, 2022.

(51) Int. Cl. G06F 3/04817

(52) U.S. Cl. CPC G06F 3/04817

(57) ABSTRACT

An icon validation system for a vehicle display is disclosed herein. The icon validation system may validate correctness and observability of icons displayed over backgrounds on a vehicle infotainment system. The icon validation system may edge detection, matching, and statistical algorithms to check various criteria of the displayed icons to determine if the icons displayed meet specified standards. When faults are discovered between the displayed icons and the check criteria, corrective action may be taken to ensure that no incorrect information is displayed. This allows the infotainment system to display graphics in the background while display static or animated safety icons over the background while maintaining continuity in the vehicle safety icon display.

### RELATED APPLICATIONS

This non-provisional patent application claims priority benefit, with regard to all common subject matter, of earlier-filed U.S. Provisional Patent Application No. 63/407,965, filed Sep. 19, 2022, and entitled “CLUSTER ICON VALIDATION.” The identified earlier-filed provisional patent application is hereby incorporated by reference in its entirety into the present application.

### FIELD

Some embodiments described herein are directed to a screen graphics and icon validation system. Specifically, embodiments of the current disclosure are directed to a graphics and icon display and validation system for a vehicle infotainment system.

### BACKGROUND

Vehicles may include a display presenting an instrument cluster presenting various information for the driver of the vehicle. For example, the instrument cluster may present speed, revolutions per minute, fuel level, and other graphics and icons indicative of various information related to the operation or status of vehicle systems and components. For example, a vehicle display may present icons to warn or notify a user of system and component malfunctions or errors. Some conventional displays present warnings on a rich graphical user interface over an opaque background, which may not blend into the other content presented on the user interface.

### SUMMARY

Embodiments of the present disclosure provide a first embodiment directed to an icon validation system comprising a vehicle display associated with a vehicle, the vehicle display configured to present graphics and an icon indicative of a state of the vehicle, a memory configured to store a plurality of icons, and a processor configured to detect an icon when overlaid on the presented graphics on the vehicle display, compare the detected icon with the plurality of icons, based on the comparison, validate the icon for overlay on the displayed graphics, and present the validated icon overlaid on the graphics on the display.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the disclosure will be apparent from the following detailed description of the embodiments and the accompanying drawing figures.

### BRIEF DESCRIPTION OF THE DRAWING FIGURES

Embodiments of the disclosure are described in detail below with reference to the attached drawing figures, wherein:

FIG. 1 depicts an exemplary hardware system for embodiments of the disclosure;

FIG. 2 depicts an exemplary instrument cluster for some embodiments of the disclosure;

FIG. 3 illustrates exemplary icon color displays and background matching for some embodiments of the disclosure;

FIG. 4 continues with the exemplary icon color displays and background matching of FIG. 3 for some embodiments of the disclosure;

FIG. 5 depicts an exemplary background resulting in low observability of the icon;

FIG. 6 depicts exemplary matching criteria for some embodiments;

FIG. 7 depicts an exemplary method of validation across safe and unsafe environments;

FIG. 8 depicts an exemplary animation for some embodiments of the disclosure;

FIGS. 9A and 9B depict an exemplary instrument cluster and safety icon overlay;

FIGS. 10A-10C depict an exemplary infotainment system for implementing embodiments of the disclosure;

FIG. 11 depicts an exemplary primary display;

FIG. 12 depicts an exemplary secondary display;

FIG. 13 depicts an exemplary secondary display including climate controls;

FIG. 14 depicts an exemplary secondary display; and

FIG. 15 depicts an exemplary supplemental display including load and trailer status.

The drawing figures do not limit the disclosure to the specific embodiments disclosed and described herein. The drawings are not necessarily to scale, emphasis instead being placed upon clearly illustrating the principles of the disclosure.

### DETAILED DESCRIPTION

The following detailed description references the accompanying drawings that illustrate specific embodiments in which the current disclosure can be practiced. The embodiments are intended to describe aspects in sufficient detail to enable those skilled in the art to practice those embodiments of the disclosure. Other embodiments can be utilized, and changes can be made without departing from the scope of the current disclosure. The following detailed description is, therefore, not to be taken in a limiting sense. The scope of the disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Embodiments of the present disclosure relate to an automotive display in communication with at least one processor configured to utilize techniques to present graphics and icons providing information related to the operation and/or the status of vehicle systems and components. The icon display and validation system may provide, within a digital instrument panel, accurate drawing graphics or icons and validate the drawn content presented (and, in some cases, to be presented) by the vehicle display.

In some embodiments, the icon display and validation system may store computer-executable instructions for employing an object detection and classification algorithm for detecting and classifying the graphics and icons displayed. Furthermore, in some embodiments, the icon display and validation system may provide a matching algorithm and determine an error amount between data indicative of a stored graphic and/or icon and the displayed graphic and/or icon to determine a likelihood of a match. Using the functionality described herein, the icon validation system may determine a shape and validate an observability of the icon relative to a background. This process may verify that the icon and graphics are displayed to any manufacturer and/or vehicular standards.

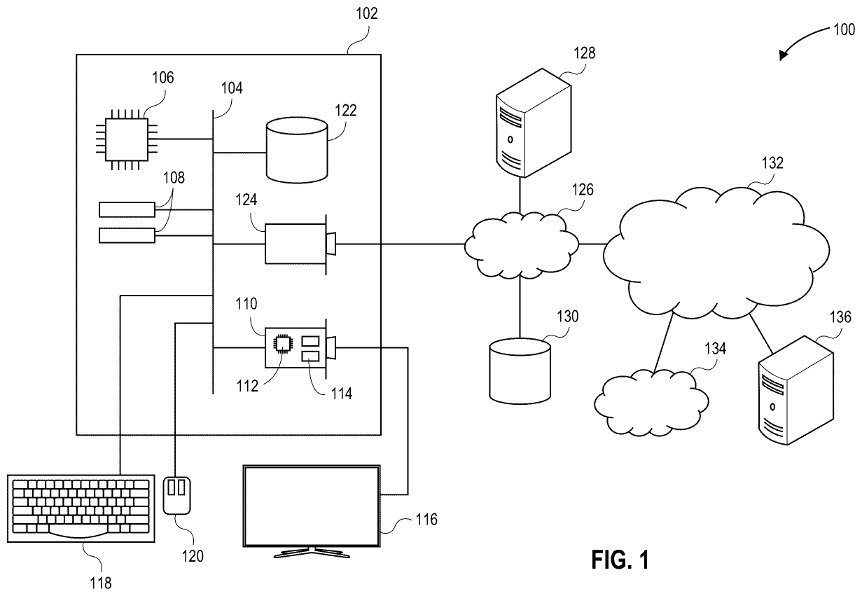

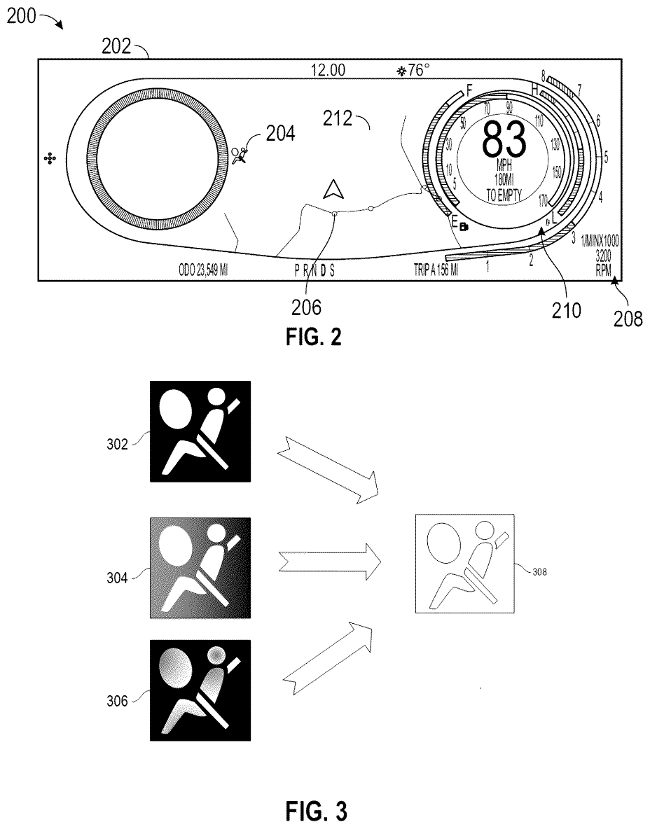

FIG. 1 illustrates an exemplary hardware platform representative of an embodiment of icon and graphics display and validation system (icon validation system 100). Computer 102 can be any computer associated with or providing a vehicle instrument cluster and/or any form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 110 may not be a physically separate card, but rather may be integrated into the motherboard or the CPU 106. In some embodiments, graphics card 110 has a separate graphics processing unit (GPU) 112, which can be used for graphics processing or for general purpose computing. GPU 112 may provide graphics and icon generation and validation as described in embodiments below. Also on graphics card 110 is GPU memory 114. Connected (directly or indirectly) to graphics card 110 is display 116 for user interaction. In some embodiments no display is present, while in others it is integrated into computer 102. In some embodiments, display 116 is vehicle display 200 (FIG. 2). Similarly, peripherals such as keyboard 118 and mouse 120 are connected to system bus 104. These peripheral devices, in some embodiments, may be linked for input and updating icon validation system 100. Like display 116, these peripherals may be integrated into computer 102 or absent and may be provided as inputs by display 116. Also connected to system bus 104 is local storage 122, which may be any form of computer-readable media and may be internally installed in computer 102 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store non-transitory data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations. In particular, computer readable media includes non-transitory computer readable media storing computer-executable instructions that, when executed, cause one or more processors to carry out operations.

Finally, network interface card (NIC) 124 is also attached to system bus 104 and allows computer 102 to communicate over a network such as local network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write, and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

Embodiments of the present disclosure are directed to an automotive instrument cluster (vehicle display 200) shown in FIG. 2. Vehicle display 200, in some embodiments may be display 116, may be in communication with a processor (e.g., CPU 106, GPU 112, or the like), which in some embodiments may be a plurality of communicatively connected processors. The processor, as referenced herein, may comprise any or all processing components of icon validation system 100 including CPU 106 and GPU 112. The processor may be configured to accurately present graphical icons providing information related to the operation and/or status of vehicle systems and components. Icon validation system 100 may display images within digital instrument panel 202 by accurately drawing graphics or icons using the stored computer-executable instructions described herein. Furthermore, icon validation system 100 may run validation algorithms for validating the displayed icons and drawn content and icons. Furthermore, icon validation system 100 may validate content to be displayed and validate observability of icons based on a contrast between the icons and a background of digital instrument panel 202.

Icon validation system 100 may implement edge detection techniques of the presented graphics and icons and compare the results with a stored graphic and/or icon to perform matching functionality to ensure that the intended graphics and icons are presented correctly. These processes, for example, may reduce the impact of static or dynamic content over which the graphics and icons are presented (e.g., a blurred background image). For example, various graphics and icons may be changed based on color and shape of the icons and displayed graphics such that the icons are highly visible or comprise a high observability factor.

As shown in FIG. 2, digital instrument panel 202 may provide graphics such as, for example, safety icon 204, map 206, engine rpm 208, and speedometer 210. Many more graphics may be displayed by digital instrument panel 202 as instructed by the processor as describe herein.

As shown in FIG. 3, icon validation system 100 may display safety icon 204 in various ways. For example, first icon 302 is display with a solid background and a flat icon while second icon 304 is displayed with a color gradient background and a flat icon, while third icon 306 is displayed with a color gradient and a shaded, or three-dimensionally shaded, icon. All three icons result in a similar edge detection result 308 as detected by the algorithms described herein. Here, safety icon 204 may be displayed with various backgrounds that provide high visibility and high detectability by the various edge detecting algorithms described below.

In some embodiments, the edge detection algorithms compare areas of digital instrument panel 202 such as pixels or elements of the display and provide a likelihood that each area is either part of the displayed graphic or part of the background. Larger and larger areas may be identified such that the entire outline, or edge, of the feature is determined with an associated probability. As shown in the edge detection result 308, a driver with a seatbelt and an airbag is detected. As such, safety icon 204 may indicate that the drive is wearing a seatbelt and the airbag is engaged. However, safety icon 204 may present any icon type or icon design.

In some embodiments, the algorithm detects a shape of the icon and/or graphic as a whole rather than each individual pixel. For example, an area comprising the entire icon may be analyzed. The shape of the icon may be detected utilizing edge detection of the color contrast between the background and the icon rather than detecting and classifying each individual pixel. This detection process allows icon validation system 100 to determine an entire shape of safety icon 204 for matching to stored icon shapes. The algorithm may iteratively compare the detected shape with the stored shape determining an error between the shapes. The stored icon with the least associated error may be a match to safety icon 204 with a corresponding likelihood.

In some embodiments, the processor (e.g., CPU 106, GPU 112, or the like) can utilize various edge detection algorithms to extract information from digital images displayed by vehicle display 200. One common type of edge detection algorithm is the Sobel operator, which calculates the gradient magnitude of the image (e.g., safety icon 204) using a 3×3 kernel. This algorithm highlights edges by detecting changes in pixel intensity values across adjacent pixels. Another type of edge detection algorithm is the Canny edge detector, which utilizes a more complex process involving signal processing techniques such as smoothing, gradient calculation, non-maximum suppression, and hysteresis thresholding. The Canny edge detector is known for its ability to accurately detect edges with low noise and high precision.

In addition to the Sobel operator and Canny edge detector, the processor can also use the Laplacian of Gaussian (LoG) algorithm for edge detection. The LoG algorithm is a multi-stage process that applies a Gaussian filter to the image to smooth out noise, followed by a Laplacian filter to detect changes in pixel intensity. Furthermore, the processor can employ the Prewitt operator for edge detection. The Prewitt operator is similar to the Sobel operator in that it uses a 3×3 kernel to calculate the gradient magnitude of the image. However, the Prewitt operator uses a different kernel that places more emphasis on diagonal edges, resulting in a slightly different edge map compared to the Sobel operator. This algorithm is often used in applications such as corner detection and motion detection. Overall, the selection of an edge detection algorithm depends on the specific application and the desired level of accuracy and noise reduction, and any edge detection algorithm is contemplated as being with the scope of the present disclosure.

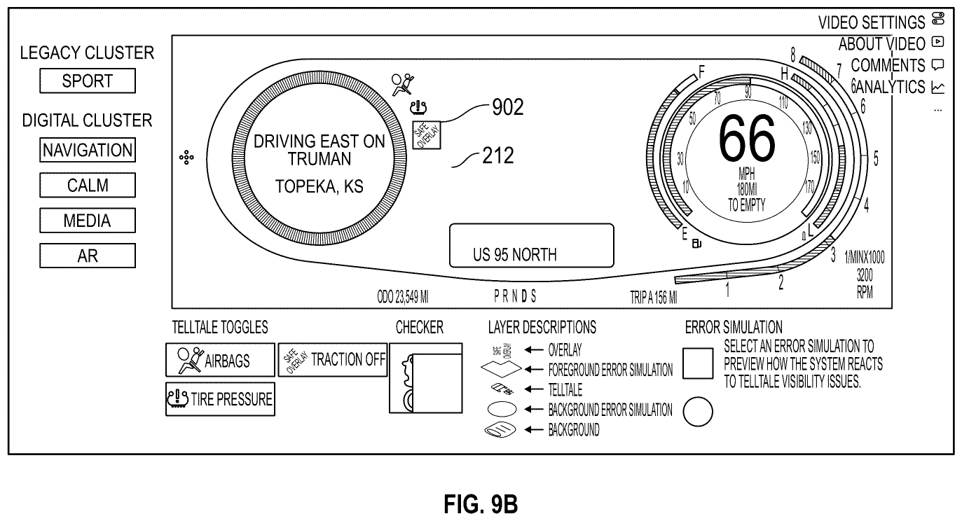

In some embodiments, an error threshold may be applied to determine an observability of safety icon 204. For example, if the error is less than the threshold value, it may be determined that safety icon 204 corresponds to the stored icon with a high likelihood. This also may indicate that safety icon 204 has a high detectability and potentially a high observability for the user. Similarly, or alternatively, if the error is greater than the threshold value, the matching algorithm may not find a solution. As such, the detectability and the observability may be low. When the detectability and/or the observability are low, safety icon 204 may be substituted for safety icon overlay 902 (FIG. 9B). This process is described in more detail below.

As shown in FIG. 3, halo effects, lighting effects and 3-dimensional effects have minimal impact on the accuracy and effectiveness of such techniques. As such, these techniques described herein provide robust methods of detection, classification, matching, and validation.

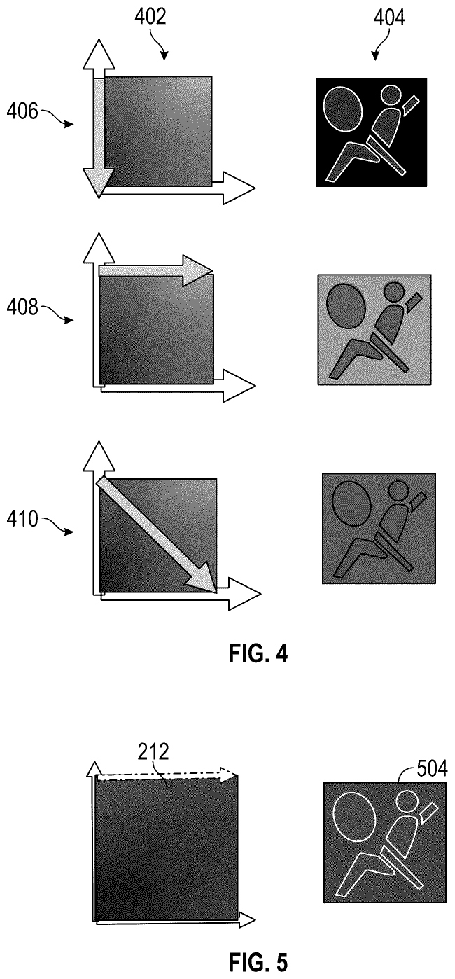

In some embodiments, as shown in FIG. 4, depending on background 212 and any other factors, icon validation system 100 may utilize different color combinations to enable the graphics and icons to be more prominent, or recognizable from the background 212. For example, a color contrast icon/background 402 can be red/black (first icon 406), red/yellow (second icon 408), red/green (third icon 410) or any other color combination. Here, the color combination is represented by various grayscale gradients; however, any color combination may be used to display stark differences between background 212 and safety icon 204. Color combinations may be selected by scanning color gradient fields and any combinations with the highest detectability and observability may be selected for display of safety icon 204 and background 212. The observability may be illustrated in column 404 representing safety icon 204 detected with the color contrast 402.

The color variations and combinations may show a stark contrast between safety icon 204 and background 212 such that the pixels displaying safety icon 204 are distinguishable from the pixels displaying background 212. This provides more accurate results when running the edge detection validation algorithm described above. Furthermore, when detecting the shape from the background in the selected area comprising the entire icon, high color contrast between safety icon 204 and background 212 may again lead to high detectability and observability. As shown in FIG. 4, icon validation system 100 may identify colors in a narrow portion of the available colors resulting in less contrast between colors that may be suitable based on colors of other content presented on the display of digital instrument panel 202.

FIG. 5 depicts an exemplary background 212 that result in a low observability factor. In some embodiments, a contrast in color may be determined by measuring the color of background 212 and the color of safety icon 204 shown with a contrasting icon/background color scheme 504. A threshold value may be compared to the determined contrast value to determine if the contrast is great enough to allow or if the color of background 212 and/or the color of safety icon 204 should be changed. For example, background 212 may be an animated movie or changing graphics that display changing colors. Background 212 may have a similar color to graphics and/or safety icon 204 displayed. As such, it may be difficult for a driver to see safety icon 204. A low contrast between safety icon 204 and background 212 may be measured as low observability as compared to a threshold value. If the observability, or contrast, is below the threshold value, the color of safety icon 204 may be changed, or safety icon 204 may be replaced with a safety icon overlay 902 as described in embodiments below.

In some embodiments, as described above, background 212 may be a changing graphic that is not controllable by icon validation system 100 such as, for example, a movie, television show, screen saver, dynamic picture, and the like. As such, only detection and observability of safety icon 204 may be utilized. Therefore, if background 212 is changing, there may be instances where a color of background 212 may be significantly similar to the color of safety icon 204. In these instances, safety icon 204 may not be detectable and, therefore, may also not be observable.

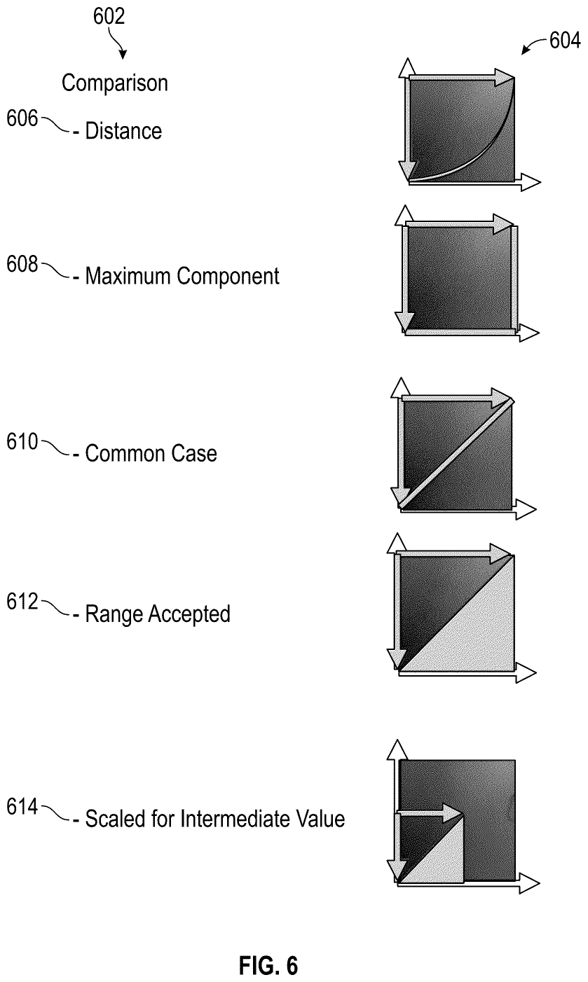

FIG. 6 depicts exemplary validation criteria 602 for comparison by icon validation system 100 between the color of the icon 204 and its background 212. The exemplary validation criteria 602 may be visualized as a projection in a two-dimensional color space such as visualization 604. For example, validation criteria 602 may include constant distance 606 between the icon and background colors, constant maximum color component 608, common case of constant sum of color components 610, acceptable ranges 612 of values between constant sum 610 and constant maximum component 608, and scaling factors 614 that result in high detection factors. All data associated with the various validation criteria validation criteria may be stored and used to train future models when results are realized. Validation criteria may not only validate the size and shape of the icons but coordinate locations as well as relative distances between the icons. Furthermore, common issues may be stored and specifically looked for or may be weighted higher when analyzing the detected icons. Furthermore, the error data calculated when the detected icon data is compared to stored features may be compared to a threshold value to determine if the displayed and detected icon is acceptable.

In some embodiments, icon validation system 100 may utilize safe environment 700 (e.g., CPU 106) and unsafe (non-safe) environment 702 (e.g., GPU 112) to ensure that certain information that is expected to be presented on digital instrument panel 202 is in fact being presented. Icon validation system 100 may request from GPU 112 a current status of content to be included within each frame presented on digital instrument panel 202. The instructions sent by CPU 106 may cause GPU 112 to execute certain instructions and related commands to assess whether certain safety-related graphics (icons) and information will be presented. For example, CPU 106 may request from GPU 112 a current status of content to be presented within each frame on digital instrument panel 202 and execution of a checksum for the graphics. CPU 106 may use the information returned from GPU 112 to validate the presentation of safety-related graphics (icons) and information within each frame by comparing the received information with expected values stored in memory.

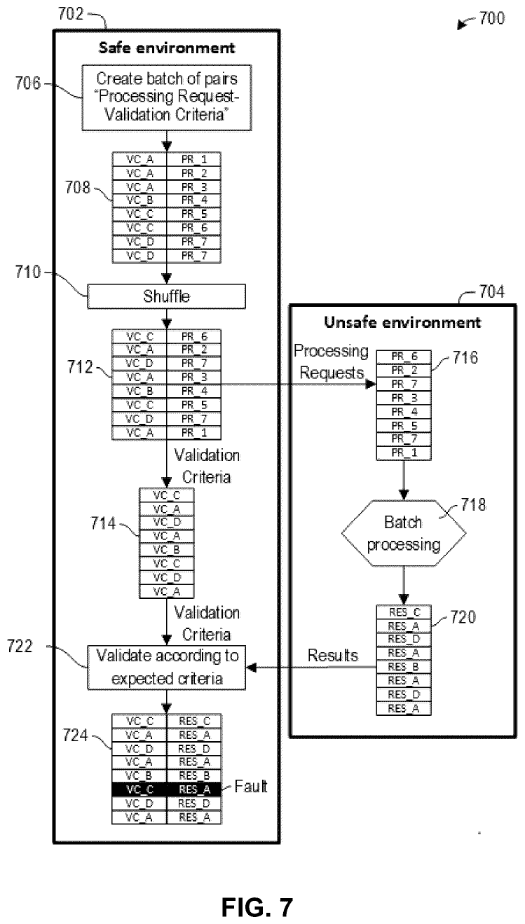

As shown in FIG. 7, safe environment 702 (e.g., CPU 106) at step 706 may generate a batch of processing requests and acceptance criteria and send to an unsafe environment 704 (e.g. GPU 112) a batch of requests and store in a memory (e.g., RAM 108 or local storage 122) an expected result for each request as the validation criteria. As shown below, safe environment 702 may create a batch of request (e.g., eight requests), which is a number chosen for illustrative purposes. At step 708 processor may store in the memory the expected value for each request (illustrated using different patterns for each type of request and different colors, for the expected result of each). In some embodiments, illustrated at step 710, processor may shuffle (re-order) the batch before sending each batch to ensure that GPU 112 will respond to the most recent request from the processor (instead of sending a cached response from the previous batch inquiry) as the order of responses will change as a result of the shuffling. For example, various parameters of the requests (e.g., order, offsets, addresses, etc.) may be shuffled (re-ordered) at each iteration to ensure the execution by and return of requests from the GPU 112 is not frozen (unchanged). In this example, the responses to the shuffled requests are expected to be, for example, C-A-D-A-B-C-D-A.

Processing the requests may be completed in unsafe environment 704, such as GPU 112. At step 712 the processing request may be sent to unsafe environment 704 for processing. At step 716, the processing request may be received by unsafe environment and at step 718, the request may be processed by standard procedures of GPU 112. At step 720, the result of step 718 may be output and sent back to safe environment 702 for evaluation.

At step 714, processor (safe environment 702) stores the validation criteria until the unsafe environment 704 processes the requests at step 718 and provides the results back to the safe Environment 702 at step 720. At step 720 the responses, including the results of processing by unsafe environment 704, are received by the processor. The processor may store the responses in safe environment 702 at the memory and validate the responses at step 722 by applying the validation criteria stored in memory for each request. The validation criteria may be any function of one or more responses. For example, this function may evaluate if one or more values are below a threshold, above a threshold, or within a predetermined range.

In some embodiments, assessment of certain responses may be conditioned on the value of other responses. For example, if the first response is above a predetermined threshold, then determine whether a checksum provided in a second response is equal to a stored reference checksum. In this example, the responses are C-A-D-A-B-A-D-A as shown at step 720. When compared to the above-stated expectation result of C-A-D-A-B-C-D-A, results in the processor confirming that seven of the batch of eight requests is as expected. For the sixth response, which does not match the expected response stored in memory (i.e., the response is A instead of C), the processor will generate a fault for that response at step 724.

In some embodiments, the processor may assess a fault based on one or several failing conditions. For example, several results like error counters may be cumulated to check whether the cumulated error counter is above or below a stored error threshold. Similarly, with an animation, only one (or more) of a plurality of reference frames and checksum for each should match the frame (or frames) being presented on vehicle display 200.

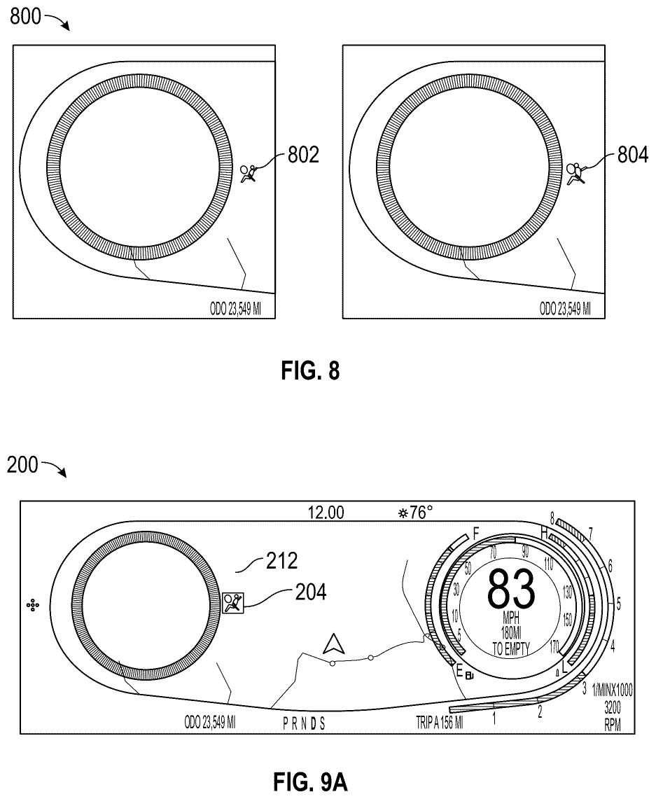

As shown in FIG. 8, animation 800 is a series of graphics presented sequentially to present a moving illustration of a safety warning (e.g., safety icon 204) or safety information. As shown in the sequential frames, first frame 802 and second frame 804, the driver is leaning toward an airbag indicative of being in an accident. Safety icon 204 shows that the airbag is active. Therefore, in the event of an accident, the airbag will be deployed.

When a fault in safety icon 204 is detected as described above, icon validation system 100 may take corrective actions or other safety measures. For example, icon validation system 100 may send instructions to draw a known and opaque icon at a specific location of each frame while the fault persists. Similarly, icon validation system 100 can force the display to turn off to not display any incorrect information.

The type, number and order of the requests may be determined and selected by the processor based on one or more safety analyses, such as the Failure Mode and Effects Analysis (FMEA) process, which cover all possible faults that may occur in unsafe environment 704. For example, the order of requests for each batch of requests may be changed to ensure that responses received from GPU 112 are to the most recent request instead of a previous batch inquiry based on the type or format of individual responses to each batch inquiry.

FIG. 9A depicts an exemplary safety warning icon (e.g., safety icon 204) by vehicle display 200. Vehicle display 200 may present a rich graphical user interface including various content presented to the driver (e.g., map 206 containing navigation information, infotainment information, entertainment content, etc.) that could result in safety warning(s) (icons) and/or safety information not being presented to the driver or may make perception of safety warning(s) (icons) and/or safety information that is presented difficult to perceive. The techniques disclosed herein enable vehicle systems to confirm that such safety warning(s) (icons) and/or safety information are being presented to the driver and are being presented in a manner that adequately notifies the driver. For example, in some embodiments, vehicle display 200 may be configured during autonomous driving situations to present entertainment content (e.g., film or music videos, audio visualizers, etc.) to the driver, and icon validation system 100 may implement the disclosed techniques to present safety warning(s) (e.g., safety icon 204) and/or safety information over such entertainment content in a manner that adequately notifies the driver of any issue(s). In embodiments, certain entertainment content may need to be stored in the memory in a manner that restricts access by the processor and GPU 112 for limited use (e.g., retrieval for presentation purposes only). For such restrictions, the techniques disclosed herein enable icon validation system 100 to generate and send a batch of requests related to the content to be presented on vehicle display 200 in an unsafe (non-safe) environment, such as GPU 112, to ensure the presentation of safety-related graphics (icons) and information as intended by icon validation system 100 while complying with any restrictions applicable to storage, access, and use of the entertainment content.

An example shown in FIG. 9A illustrates background 212 presented behind safety icon 204. Background 212, in this case, may be any graphics described above. Background 212 may be animated, changing color and shapes such as a movie or a moving image. Safety icon 204 may be displayed as the analysis described above may determine that safety icon 204 is visible and detectable and does not have faults (or includes faults below a minimum error threshold) as described above. Alternatively, as shown in FIG. 9B, background 212 may provide a conflict with safety icon 204. As such, to not display incorrect information, safety icon 204 may be replaced by safety icon overlay 902.

Accordingly, icon validation system 100 may ensure that vehicle display 200 presents safety warning(s) (icons) and/or safety information on a rich graphical user interface over other content presented on the user interface by generating and sending a batch of requests to GPU 112, generate and store in a memory accessible to the processor an expected criteria (e.g., value, predetermined range of an expected result, a condition for assessing certain responses, etc.), assessing various possible failures in GPU 112 based on fault analyses such as Failure Mode and Effects Analysis (FMEA) from the functional safety development process, such as possible corruption of GPU memory 114 (a checksum can confirm that such an event has not occurred) computational failure or data transmission error, validating the responses by comparing each with the expected result (the validation criteria) stored in memory and taking corrective action based on which request is unexpected or once a threshold number of faults is exceeded. As shown in FIG. 9B, background 212 is presented between the persistent (top layer of content that cannot be obscured by other content) and other content presented on vehicle display 200 to demonstrate the presentation of safety-related graphics (icons) and information is presented by GPU 112 as intended by the processor (e.g., CPU 106).

### Example Environment

The following text sets forth an example environment in which the display features described herein may be implemented. However, it is understood that the description is to be construed as exemplary only and does not describe every possible embodiment as describing every possible embodiment would be impractical. In light of the teachings and disclosures herein, numerous alternative embodiments may be implemented.

Vehicles that may contain components of the system include, but are not limited to, automobiles, trucks, buses, two-wheeled motor vehicles, aircrafts, boats and other watercrafts, and any mobile structures capable of transporting loads of material to one or more geographic locations.

Various implementations of the system provide a comprehensive solution that simplifies the interface for vehicles while adding greater depth to the content available in the vehicle. The system serves as an intermediary between the vehicle operator, the vehicle, and remote systems. The system described herein may be communicatively coupled to icon validation system 100. For example, in some configurations, two or more large electronic display panels are coupled with a vehicle dashboard to present various information to a vehicle operator. The display panels discussed herein (e.g., primary display panel 1002, secondary display panel 1004, supplemental display panel 1006) may be or may comprise vehicle display 200 for implementing embodiments of the above-described disclosure. One or more of the displays may be a touchscreen to facilitate operator input. Further, it should be emphasized that the term input, when used in this description and in the appended claims to indicate included features, elements, or steps, is in no way to be interpreted as excluding the use of input controls independent of a touchscreen. In some embodiments, operator input may be provided using input controls coupled with a steering wheel or the vehicle's center console, armrest, or support trim. In some embodiments, the input controls may comprise a touchscreen.

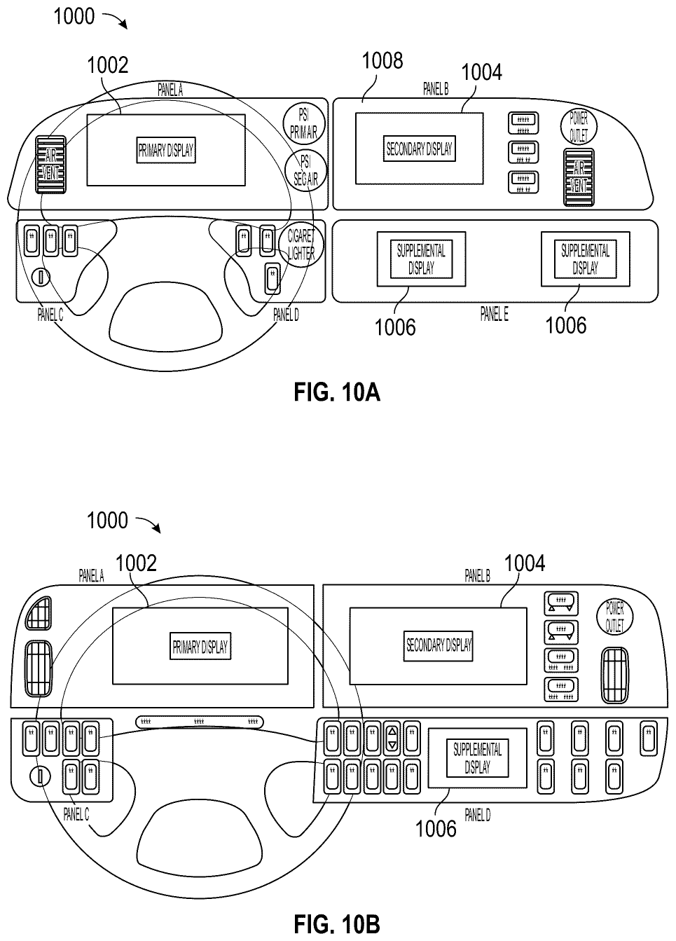

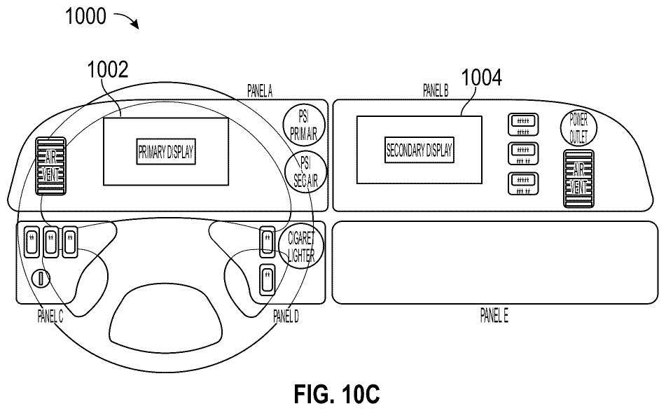

As shown in FIGS. 10A-10C, the vehicle infotainment system 1000 (“the system”) may include two or more independent display panels(e.g., primary display panel 1002, secondary display panel 1004, and supplemental display panel 1006) of sizes suitable for installation on dashboard 1008 or other locations in the cab. Dashboard 1008 may be primarily flat against the front of the cabin, have portions protruding from the front of the cabin, curved to provide optimal accessibility for the vehicle operator and passengers, or separated with portions positioned above the windshield.

The system may employ a variety of configurations to maximize accessibility and aid in the visibility of the display panels within the vehicle cab. In some embodiments, the display panels are installed, or may be adjusted to be positioned, to be within an arm's length distance of the operator to provide for touch input. The display panels may be installed in other areas of the cab, such as the cab sleeper area, for use at times when the vehicle is stationary and/or in motion. In some configurations, the contents of various display panels may be consolidated into a single display panel. The single display panel would also be mounted within the operator's arm's length proximity. In some embodiments, the system may be configured to externally mount the display panels or communicate the contents of the display panels using a portable electronic device.

The system may use one or more sub-systems to provide functionality to assist the vehicle operator with operating the vehicle and/or management of services related to the operation of the vehicle. In some embodiments, these sub-systems may be started automatically if the system determines that certain conditions exist. For instance, one or more sub-systems may be started if the system determines that the operator's visibility may be limited (e.g., nighttime, fog, heavy precipitation, etc.).

The system communicates information to the operator and receives information from the operator in a seamless and efficient manner. In some embodiments, the system uses two or more display panels to communicate information to the operator and an interface for the operator to input control commands to manage elements controlled by the system.

The system is capable of receiving information and/or control commands from the vehicle operator, wireless data broadcasts, and remote servers. The interface between the system and vehicle operator may provide for operator input control commands using push-buttons, touch-sensitive display panels with infrared (IR), resistive, or capacitive technology, universal serial bus (USB) devices, external keyboards, audible communications including automatic speech recognition (ASR) functionality, open wireless technologies for exchanging data over short distances from fixed and mobile devices of communication including, but not limited to, analog radio frequency (RF), personal area networks (i.e., Bluetooth, infrared (IR) wireless, ultra wideband (UWB), ZigBee, etc.), and wireless local area networks (i.e., IEEE 802.11). The methods used by the system to receive information using wireless data broadcasts may include standardized or proprietary signal broadcasts from broadcast towers and base stations installed at fixed or mobile locations. For instance, the system may include a transceiver capable of transmitting and receiving communication signals for Citizens' Band (CB) radio. The system may communicate CB radio signals with operators and passengers traveling in another vehicle or by individuals using a CB radio base station installed at a fixed location. In some embodiments, the system may receive wireless data broadcasts from warehouses broadcasting low-power signals for vehicles that visit the warehouse for picking up and/or dropping off loads. The methods that may be used by the system to receive information from remote servers include long-range and short-range wireless networks include, but are not limited to, frequency modulation (FM), orbital and land-based satellites, cellular phone networks, and other wireless methods (e.g., Wi-Fi (IEEE 802.11), Bluetooth, infrared (IR) wireless, ultra wideband (UWB), ZigBee, etc.). For instance, the system may include one or more radio modules for receiving and transmitting signals for wireless data broadcasts and communication with remote devices. In one embodiment, the system includes a cellular transceiver for transmitting and sending data to and from one or more remote servers. In one implementation, the cellular transceiver is a GSM modem. The GSM modem may be coupled with an external cellular antenna that connects to the rear of the system. In some implementations, the system may include an integral antenna to eliminate the need for a cumbersome and difficult-to-install external antenna. For instance, a GSM antenna may be integrated within the GSM modem, which may in turn be placed towards the face of the system (e.g., within or near the system's faceplate to enable cellular reception).

The system is designed to provide information, routes, and scheduling guidance based on the current location of the vehicle, fuel, and materials being transported using the vehicle. Scheduling guidance may include optimum layover points based on hours an operator has operated the vehicle. If the operator is restricted by a maximum number of hours the vehicle may be operated, the scheduling guidance may incorporate the hours a vehicle was operated and the hours available for operating the vehicle. In some embodiments, the location determining component is used to determine the current location of the vehicle. The system may automatically adjust if it determines that the current location of the vehicle requires adjustment of one or more elements. For instance, the legal requirements and customs may be adjusted automatically if the system determines that the vehicle has crossed the border from a country that uses the metric system to a country that uses another system of measurement, such as the U.S. customary system using inches and miles, the system will automatically adjust the navigation system, the instrumentation (i.e., units for measuring vehicle velocity), and driving and load regulations for the country in which the vehicle has entered.

The display panels may include primary display panel 1002, secondary display panel 1004, and one or more supplemental display panel 1006. Depending on the type of vehicle, the display panels may be positioned on dashboard 1008, a console mounted onto the vehicle cabin floor, above the vehicle windshield, in the vehicle cab sleeper, below the instrument panel either entirely on or partially on the cabin floor panel, or external from the cab. In some embodiments, the display panels may be adjusted to move or tilt from the mounted position to any position. For instance, a display panel installed in dashboard 1008 may be moved closer to or further from the vehicle operator, tilted in three hundred and sixty degrees, or any other position to allow the operator to access its contents.

The display panels may provide functionality that presents content in a high-resolution image while enabling user input of control commands. The display panels may visually present content using a liquid crystal display (LCD), light-emitting diode (LED) display, plasma display panel (PDP), holographic, or other electronic visual display methods. The display panels may provide for user input by using a touch screen with infrared (IR), resistive, capacitive, or other touch sensing technology.

As shown in FIGS. 10A-10C, some configurations of the system may use any combination of primary display panel 1002, secondary display panel 1004, and one or more supplemental display panels 1006, if any. For instance, secondary display panel 1004 may be positioned adjacent to, below, integrated with, or on the opposite side of the windshield to primary display panel 1002. Primary display panel 1002 may be positioned in a location within the cab where the vehicle operator may view all of its contents. As shown in FIGS. 10A-10C, primary display panel 1002 may be positioned directly in front of the steering wheel in some instances.

Primary display panel 1002 may be used to communicate current vehicle instrumentation readings and information of high importance to the vehicle operator. The system provides functionality for the vehicle operator or a third party to customize the contents of primary display panel 1002. For instance, the contents of primary display panel 1002 may be customized to include optional instrumentation readings that the vehicle operator has selected to be presented in addition to default and/or legally required instrumentation in the instrument panel.

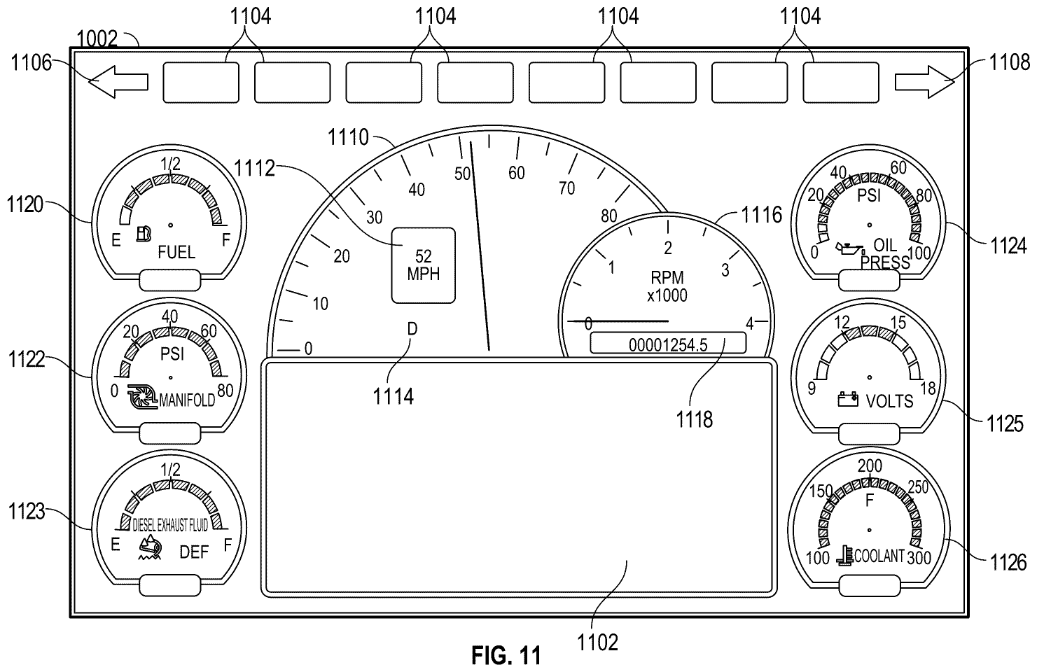

Primary display panel 1002, illustrated in FIG. 11, may also include one or more high resolution information center displays 1102. The information center displays 1102 provide flexibility in the display output for the system. In some embodiments, the information center displays 1102 are used to interchangeably present all new and/or existing content that is not currently presented on other portions of the primary display panel 1002 or other display panels.

A secondary display panel 1004 may be used to present instrumentation, information, and entertainment content. The presented content may be stored and/or originated locally or remotely.

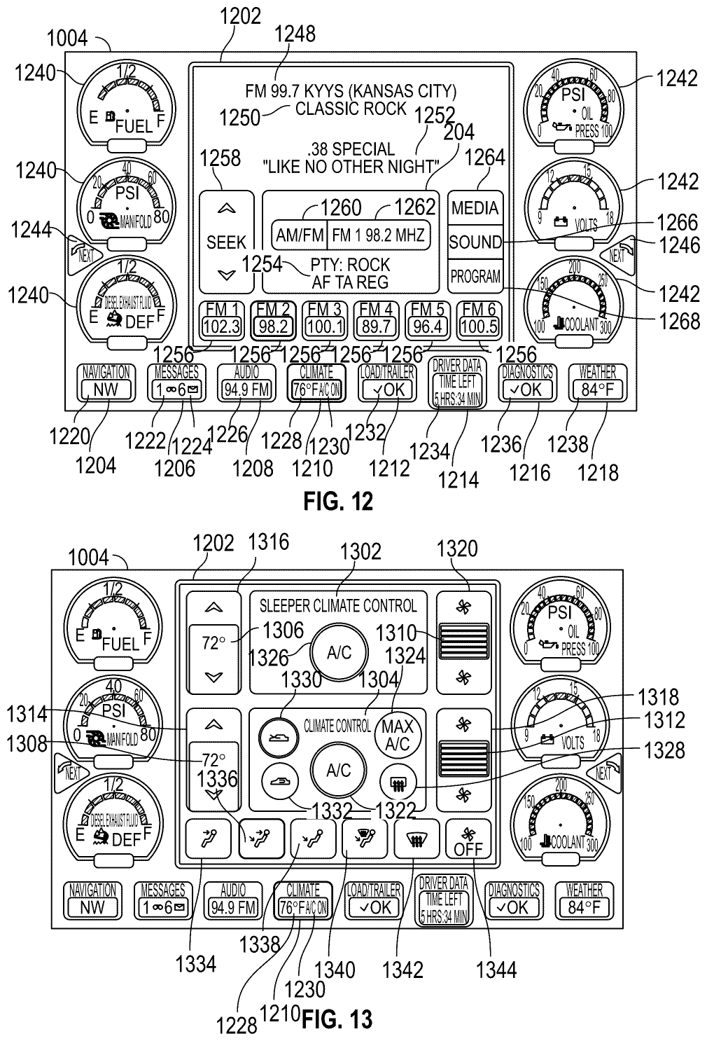

As shown in FIGS. 12-15, the secondary display panel 1004 may be used primarily to provide an interface mode for the vehicle operator to input control commands to manage the navigation, messaging, audio, climate control, trailer information, driver data, diagnostics, and weather interface modes. In some embodiments, two or more of the interface modes may be available simultaneously on the secondary display panel 1004.

One or more supplemental display panels 1006 may be used to provide additional system flexibility. One or more supplemental display panels 1006 may present the same content as primary display panel 1002 and secondary display panel 1004. As shown in FIGS. 10A and 10B, there are various configurations for infotainment system 1000 to incorporate one or more supplemental display panels 1006.

The system may also include one or more routing modules to process cartographic data in conjunction with one or more location determining components (i.e., GPS receivers). The cartographic data may be stored within the memory and/or acquired from a remote service via one or more communication elements. The routing module is representative of functionality to determine a suitable route between two locations. The routing module may use cartographic data to determine the shortest, fastest, optimal autonomy (e.g., battery impact) and/or most fuel economical route between two locations. For instance, the routing module may be used to route the vehicle to any destination, calculate the estimated time of arrival (ETA), the estimated autonomy and determine the status of the vehicle compared to the scheduled locations (i.e., ahead of schedule, behind schedule, or on schedule), or update the route to meet scheduling requirements. The routing information may be presented to the operator using any of the display panels and/or audible communications.

The system may further include functionality enabling it to identify and manage the vehicle operator. In some embodiments, the vehicle operator may be identified from a key, electronic vehicle entry or operation device (e.g., keyless entry transmitter, vehicle remote start transmitter, portable media device, cellular telephone, etc.). The system may manipulate information presented to the vehicle operator in an arrangement associated with the vehicle operator. For instance, the system may identify a vehicle operator and customize the information presented to him accordingly. If the system identifies multiple vehicle operators alternating vehicle operation, the system may manage the driving schedules of both drivers. In some embodiments, the vehicle may modify adjustable elements, such as the operator's preferred time of day to operate the vehicle, preferred route characteristics, to accommodate the identified vehicle operator.

The system may further include one or more processors, memory, communication modules, sensors, media drives, coolers, fans, and connectors to add additional hardware. One or more of these components may perform the functions and operations stated herein.

In some embodiments, the information, content, and control commands may be limited when the current velocity of the vehicle exceeds a predetermined threshold velocity. For instance, the predetermined threshold velocity may be five miles per hour.

As shown in FIG. 11, primary display panel 1002 may be used to present a digital instrument panel portion (e.g., digital instrument panel 202) and one or more information center displays 1102. The system provides functionality allowing the operator to customize the presentation and/or appearance of elements presented in primary display panel 1002. The content of the digital instrument panel portion and the information center displays 1102 may be resized or repositioned by the system, third party, or the operator. For embodiments where the primary display panel 1002 is configured as a touch screen, the digital instrument panel portion may present switches providing for user input.

The digital instrument panel portion presents instrumentation content communicating information on the vehicle's operation. The digital instrument panel portion may encompass all of the contents of primary display panel 1002 excluding information center display 1102. In some embodiments, the contents presented by primary display panel 1002 may be limited to only the digital instrument panel portion. The system may also present some or all of the content of the digital instrument panel portion in the form of an analog tachometer reading or an instant reading.

The instrumentation content that is presented to the operator in the digital instrument panel portion may include, but is not limited to, diagnostic warning indicators 1104, left turn signals 1106, right turn signals 1108, analog speedometers 1110, instant speedometers 1112, active gears for the transmission 1114, engine tachometers 1116, odometers 1118, and any other sensor readings or calculations related to the performance of the vehicle or trailer. The diagnostic warning indicators 1104 may be associated with content presented on the secondary display panel 1004. In some embodiments, diagnostic warning indicator 1104 may present a current status of a system presented on secondary display panel 1004. The presented sensors and gauges may include, but are not limited to, fuel gauges 1120, pressure sensors 1122, exhaust fluid levels 1123, oil pressure sensors 1124, battery voltages 1125, coolant temperature sensors 1126, oil temperature sensors, clock, amperage for electrical system, air filter sensor, suspension loads for various points along the cargo trailer, oil sensors for drive axles, brake pressure sensors, brake air tank pressure sensors, headlight indicators, taillight indicators, cargo trailer environment sensors, and various other notifications that may be commonly used in a vehicle's instrument panel.

The digital instrument panel portion may present information related to the vehicle's instant velocity, e.g., speed, using an analog speedometer 1110 and/or instant speedometer 1112. The system provides functionality allowing the vehicle operator to customize the content by manually adjusting the units of the presented speed information between miles per hour (mph), kilometers per hour (kph), or any other measurement indicating the vehicle's traveling rate.

In some embodiments, the system may automatically adjust the measurement units of the vehicle's speed to the measuring system that is used in the current geographic location of the vehicle. The system may use the location determining component to determine the current location of the vehicle. For instance, if the system determines that the vehicle has transitioned from a geographic region where the metric system is used to a geographic region where the US customary units are used, the system may automatically change the units of indicating speed from kilometers per hour (kph) to miles per hour (mph).

The digital instrument panel portion may also provide information regarding the fuel economy for the vehicle. This includes, but is not limited to, historic fuel economy data, current fuel economy estimate based on engine performance, and fuel economy forecasts based on travel information. In some embodiments, the system may determine, and present an indication to the operator of the optimal moment to shift transmission gears based on performance and/or fuel economy criteria.

The digital instrument panel portion may also provide information regarding the battery for the vehicle. This includes, but is not limited to, electric consumption data, current autonomy estimate based on engine performance, consumption of devices like heating system, and/or travel information. In some embodiments, the system may determine, and present an indication to the operator of the optimal moment to shift transmission gears, change engine output, change regenerative braking settings, and the like based on performance and/or autonomy criteria.

The digital instrument panel portion may also provide information regarding the distance traveled by the vehicle. In some embodiments, this includes presenting one or more odometers 1118. Odometer 1118 may indicate the total distance traveled since the vehicle was manufactured and the distance traveled since the odometer was reset. In some embodiments, odometer 1118 may present the remaining distance to a point of interest or turning point, which may be calculated by the system or inputted by the operator.

In some embodiments, dynamic lane guidance functionality is used to assist the operator with determining which lanes properly position the vehicle for upcoming road variations, turn points, and intersections.

In some embodiments, lane detection functionality is used to assist the operator with determining whether the vehicle may have inadvertently crossed a driving road lane boundary and entered another road lane or shoulder area. In some embodiments, the system may determine the current position of the vehicle relative to driving road lanes by using image pattern recognition and/or a location determining component.

In some embodiments, collision monitoring functionality is used to assist the operator with determining the presence of objects located in front of or behind the vehicle. In some embodiments, the system uses signal reflection technologies such as infrared (IR) signal reflection and/or laser ranging systems. Signal reflection technologies detect the presence of objects by using one or more signal transmitting units and one or more receiving sensors to collect any signals that have been reflected off the surface of the objects. In some embodiments, the infrared (IR) signal reflection is used by the system to create an image of the detected object(s) based on the signals received by the receiving sensors. The system may present the images to the operator using one or more display panels or a projector system. The projector system may be a head-up display technology that presents information on the vehicle windshield or a three-dimensional technology that may be presented anywhere in the vehicle cab.

As shown in FIG. 11, primary display panel 1002 may also include one or more high resolution information center displays 1102 in addition to the digital instrument panel portion. Information center displays 1102 may be used to present any information to the vehicle operator and provide an area to receive user touch input. Information center display 1102 may enable the operator to easily be apprised of communication, navigation, and/or entertainment information regardless of that same information currently being made available elsewhere by the infotainment system 1000.

In some embodiments, information center display 1102 may be used to notify the operator of various information. The information that may be presented to the operator includes, but is not limited to, navigation interface with mapping and routing information from the routing module, wireless communication information, dynamic lane guidance, backup camera and/or sensor output, blind spot information, driver alerts, trip information, vehicle information, trailer information, diagnostic information, warnings, infotainment system settings, web browser, relevant travel information, time, and any other content the system, vehicle operator, or third party chooses to present. Wireless information that may be integrated into the system may include the communication frequency (e.g., CB radio frequency) currently being used by the vehicle operator. In some embodiments, the system may provide functionality enabling a vehicle operator to select a communication frequency, initiate and terminate the transmission of audio signals, and monitor communication frequencies for activity. Dynamic lane guidance functionality assists the operator with determining which lane to be drive in for upcoming road variations, turn points, and intersections. In some embodiments, dynamic lane guidance is linked to the routing module.

In some embodiments, the system may use information center display 1102 to present information received from a remote source, such as a remote server or wireless broadcast. For instance, information center display 1102 may present electronic messages, internet content, and other forms of electronic information.

In some embodiments, the system may present critical and/or time sensitive information, (i.e., diagnostic or communication warnings) on information center display 1102. The system may provide functionality to customize the contents to include indication of new information received from a remote source. For instance, indication may be provided from a flashing or solid dedicated icon or text that appears until it has been acknowledged by the operator. The indication of new information may be presented only for a predetermined period of time.

In some embodiments, the content or portions of content currently presented in information center display 1102 may contract and expand to show new and relevant information. As the infotainment system and/or vehicle operator change the presented content, the new and pre-existing contents may move about to various forms and positions within information center display 1102.

The system may present one or more selected interface modes within system control window 1202, as depicted in FIG. 12. The interface mode is a collection of operator inputs and information to be communicated to the operator. System control window 1202 presents information and criteria controls for the selected interface mode. In some embodiments, the content or portions of content currently presented in system control window 1202 may contract and expand to show new and relevant information. In some embodiments, the available interface modes may include navigation, messages, audio, climate, load/trailer, driver data, diagnostics, and weather. As shown in FIG. 12, the system provides functionality for the operator to select one or more interface modes using selection inputs 1204-1218, which may include, but are not limited to, navigation selection input 1204, messages selection input 1206, audio selection input 1208, climate selection input 1210, load/trailer selection input 1212, driver data selection input 1214, diagnostics selection input 1216, and weather selection input 1218.

The available selection inputs 1204-1218 may be presented anywhere in secondary display panel 1004. As shown in FIG. 12, selection inputs 1204-1218 may be positioned along the lower portion of the secondary display panel 1004. In some embodiments, the interface mode that is actively selected may be indicated in some manner by the selection input. As shown in FIG. 13, secondary display panel 1004 is in climate control interface mode and the climate selection input 1210 is highlighted along the perimeter of the input.

Selection inputs 1204-1218 may contain useful information that is presented within their boundaries to communicate some information without requiring the operator to select the interface mode. In some embodiments, the navigation selection input 1204 may contain the current heading 1220, the messaging selection input 1206 may contain voicemail information 1222 and email information 1224, the audio selection input 1208 may contain the current radio station or track information 1226, the climate selection input 1210 may contain the current or desired cab temperature 1228 and air conditioning status 1230, the load/trailer selection input 1212 may contain the trailer's diagnostic information 1232, the driver data selection input 1214 may contain driving time information 1234, the diagnostics selection input 1216 may contain the vehicle's current diagnostic information 1236, and the weather selection input 1218 may contain the current weather information 1238.

In some embodiments, the system control window 1202 allows for touch input from the operator because the secondary display panel 1004 is a touch screen. The operator may input desired changes using touch input functionality. In some embodiments, the currently selected controls are indicated in some manner, such as a different color of highlighting. As shown in FIG. 13, the currently selected climate criteria controls including sleeper air conditioning switch 1326, exterior air flow switch 1330, cabin air conditioning switch 1322, and cabin air conditioning switch 1336 are highlighted to communicate their selection to the operator.

The vehicle operator may choose to present independent enhancement elements 1240, 1242 in secondary display panel 1004. The enhancement elements 1240, 1242 may be instrumentation, communication information, or media content. In some embodiments, the vehicle operator may customize the content, size, number, and layout of presented enhancement elements 1240, 1242. As shown in FIG. 12, the presented enhancement elements 1240, 1242 may be full-size instrumentation gauges on each side of the system control window 1202.

In some embodiments, the system will change the content of independent enhancement elements 1240, 1242 when it receives an inputted control command from the vehicle operator to make such a change. For instance, the change may be a rotation introducing one or more previously hidden enhancement elements. As shown in FIG. 2, the system may change the presented enhancement elements 1240, 1242 by selecting left incrementor 1244 to change the enhancement elements 1240 or by selecting right incrementor 1246 to change enhancement elements 1242.

As shown in FIG. 12, secondary display panel 1004 may be used in an audio interface mode to provide the vehicle operator information and controls for one or more available audio sources. While the secondary display panel 1004 is in the audio interface mode, the presented contents may include any combination of one or more system control windows 1202, enhancement elements 1240, 1242, and selection inputs for available interface modes.

The system control window 1202 presents audio information and audio criteria controls. As shown in FIG. 12, the presented audio information may include audio modulation information 1248, audio genre information 1250, current track information 1252, and related audio information 1254. Additionally, the audio criteria controls may include stored channel inputs 1256, channel seek input 1258, audio modulation selection input 1260, channel grouping selection input 1262, media menu 1264, sound menu 1266, and program menu 1268.

In some embodiments, the system may automatically populate the stored channel inputs 1256 with available broadcast frequencies based on the current geographic location of the vehicle. The system may determine the current positioning data for the vehicle by using a location determining component, such as GPS components or A-GPS functionality provided by cellular network providers.

In some embodiments, where the secondary display panel 1004 is a touch screen, the system may provide for the functionality allowing the operator to touch and slide a frequency indicator along a graphical frequency range to rapidly select the desired radio frequency. Additionally, the system may provide radio present functionality that enables the operator to assign new values to stored channel inputs 12 using the touch screen by simply pressing and holding one stored channel input 1256 to assign the currently-tuned radio station as the value for that stored channel input 1256.

As shown in FIG. 13, the secondary display panel 1004 may be used in a climate control interface mode to provide the vehicle operator information and controls regarding the climate of the vehicle cab, sleeper, and trailer, if any. While the secondary display panel 1004 is in the climate control interface mode, the presented contents may include one or more system control windows 1202, enhancement elements 1240, 1242, and selection inputs 1204-1218 for available interface modes.

The system control window 1202 may present any combination of climate control information and climate criteria controls. In some embodiments, the climate control interface may be limited to cab and sleeper areas. As shown in FIG. 13, the system control window 1202 may be separated into sleeper climate control region 1302 and cabin climate control region 1304. The presented climate control information may include current vehicle sleeper temperature 1306, current cabin temperature 1308, sleeper fan level 1310, cabin fan level 1312. Additionally, the climate criteria controls may include cabin temperature adjustment 1314, sleeper temperature adjustment 1316, cabin fan adjustment 1318, sleeper fan adjustment 1320, cabin air conditioning switch 1322, cabin air max air conditioning switch 1324, sleeper air conditioning switch 1326, rear defrost 1328, exterior air flow switch 1330, circulated air flow switch 1332, air flow areas 1334-1342, and an off switch 1344.

The secondary display panel 1004 may be used in a navigation interface mode to provide an interface mode for accessing navigation information. The navigation functionality provided by the system may use the location determining component to assist the operator. While the secondary display panel 1004 is in the navigation interface mode, the presented contents may include one or more system control windows 1202, enhancement elements 1240, 1242, and selection inputs for available interface modes.

The system, which includes the location determining component, may utilize position-determining techniques such as the Global Position System (GPS) and/or other satellite and terrestrial locating systems. In this manner, the location of the system may be identified to enable the system to provide various location and navigation functionality. In various configurations, the system may include a GPS enabled device that includes a receiver that is configured to receive the signals via an antenna from various position-transmitting sources.

Global Positioning Systems (GPS) have been developed to provide accurate positioning data. In traditional GPS systems, a receiver is used to capture input signals to identify a location of the receiver with respect to one or more GPS signal sources, such as satellites. In this manner, a device including the receiver may be used to navigate from the identified location to a designated location.

When the device is provided with a library of roadways (such as streets, avenues, boulevards, paths, highways, expressways, alleys, trails) the device may be capable of indicating a route between the identified and designated locations. For example, upon accepting an end point, the device may access a library containing roadway data to indicate which roadways may be used to reach the designated location.

The presented contents of the system control window 1202 may include current position information and scheduling information that may be reviewed in the Driver Data Interface mode. The presented position information may include any combination of position-determining functionality, for purposes of the following discussion, may relate to a variety of different navigation techniques and other techniques that may be supported by “knowing” one or more locations. For instance, position-determining functionality may be employed to provide location data, timing data, speed data, and a variety of other navigation-related data. The system may be configured in a variety of ways to perform a wide variety of navigation related functions. For instance, the system may be configured for vehicle navigation as illustrated, aerial navigation (e.g., for airplanes, helicopters), marine navigation, personal use (e.g., as a part of fitness-related equipment), and so forth. Accordingly, the system may include a variety of devices to determine the position of the system using one or more of the techniques previously described.

The signals from various position-transmitting platforms may be processed by a navigation module, which may be executed by the system's processor and stored within the system's memory. The navigation module is representative of functionality that “knows” a location, such as by processing the signals obtained from the position-transmitting platforms to provide the position-determining functionality previously described, such as to locate the system, speed, time, and so forth. The navigation module, for instance, may be executed to use position data stored in the memory to show a current position on a map, and so on. The navigation module may also be executed to provide other position-determining functionality, such as to determine a current speed, calculate an arrival time, and so on. A wide variety of other examples are also contemplated.

The system may also include a routing module. The routing module is representative of functionality to determine a suitable route between two locations. The routing module may use cartographic data to determine the shortest, fastest, and/or most fuel economical route between two locations. The cartographic data may be stored within the memory and/or acquired from a remote service via one or more communication elements.

While a GPS system is described in this document, it should be apparent that a wide variety of other positioning systems may also be used, such as terrestrial based systems (e.g., wireless-telephony systems or data systems that broadcast position data from cellular towers), wireless networks that transmit positioning signals, and so on. For example, positioning-determining functionality may be implemented through the use of a server in a server-based architecture, from a ground-based infrastructure, through one or more sensors (e.g., gyros or odometers), and so on. Other exemplary systems include, but are not limited to, a Global Orbiting Navigation Satellite System (GLONASS), a Galileo navigation system, or other satellite navigation system.

The system may use supplemental display panels 1006 to present any information to the operator or receive touch input control commands from the operator. In some embodiments, the content available for presentation on the supplemental display panels 1006 is linked to the information displayed on the primary display panel 1002 and/or secondary display panel 1004.

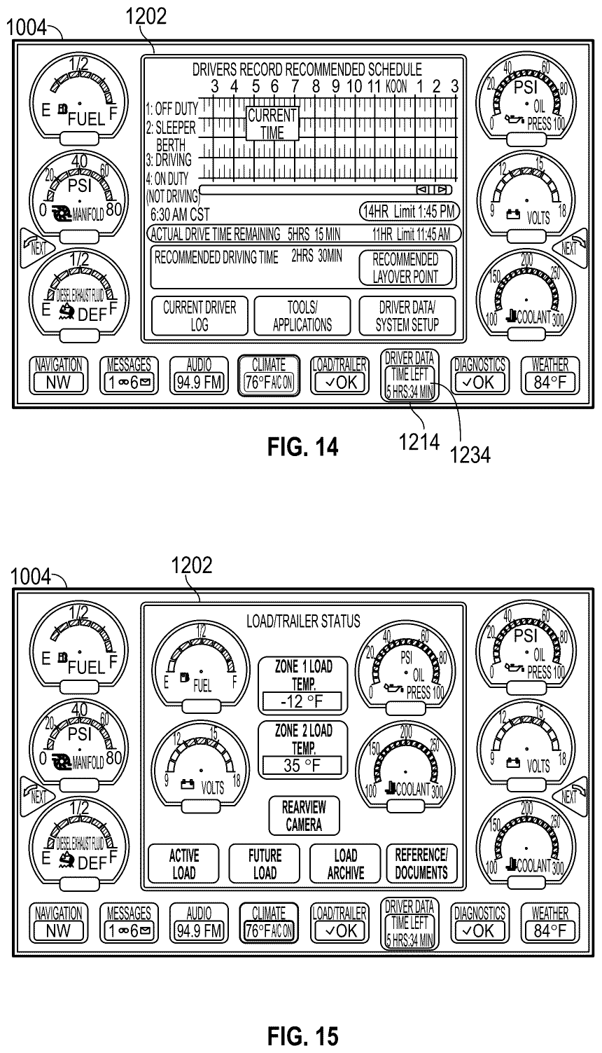

In some embodiments, the operator may control transportation and performance features of the vehicle and trailer from a single supplemental display panel 1006 as shown in FIG. 14 and FIG. 15. The supplemental display panel 1006 may allow functionality to receive an input control command using a touchscreen. The adjustment of features may be made using electrical switches presented for adjustment on a supplemental display panel 1006 that receive the operator's touch input. This adjustment method may be used to control any switch. For instance, the system may provide functionality for the operator to adjust commonly used light switches, such as those required for lights, running lights, fog lights, outdoor cab light, gauge dim lights, hazard lights, outside beacon light, auxiliary running lights, sleeper lights, rear air conditioning, and rear lights.

In some embodiments, the vehicle operator may adjust performance related components, such as engine fan, engine brake, DPF emission, cruise control, and cruise select. Additionally, the vehicle operator may also adjust critical vehicle and trailer settings, such as the height and/or firmness of the trailer air suspension, air suspension, locking and/or unlocking of the fifth wheel, and the locking and/or unlocking of the differential.

In some embodiments, the independent enhancement elements 1240 and 1242 in the secondary display panel 1004 may be instrumentation content (e.g., gauges). The instrumentation content available for use as independent enhancement elements 1240 and 1242 in the secondary display panel 1004 may comprise other alternative gauges.

Although current disclosure has been described with reference to the embodiments illustrated in the attached drawing figures, it is noted that equivalents may be employed, and substitutions made herein without departing from the scope of the disclosure as recited in the claims.

Having thus described various embodiments, what is claimed as new and desired to be protected by Letters Patent includes the following.

1. An icon validation system comprising:
a vehicle display associated with a vehicle, the vehicle display configured to present graphics and an icon indicative of a state of the vehicle;
a memory configured to store a plurality of icons; and
a processor configured to:
detect an icon when overlaid on the presented graphics on the vehicle display;
compare the detected icon with the plurality of stored icons;
based on the comparison, validate the icon for overlay on the displayed graphics; and
present the validated icon overlaid on the graphics on the display.

2. The icon validation system of claim 1, wherein the processor is further configured to detect the icon based on its shape using an edge detection algorithm.

3. The icon validation system of claim 2, wherein the processor is further configured to compare a background color of a background of the vehicle display with an icon color of the icon and determining an observability of the icon.

4. The icon validation system of claim 3, wherein the processor is further configured to display a safety icon overlay over the icon when the observability of the icon is below an observability threshold.

5. The icon validation system of claim 4, wherein the icon is animated.

6. The icon validation system of claim 4, wherein the background is animated.

7. The icon validation system of claim 1, wherein the processor is further configured to:
generate one or more criteria for validating the icon including a processing request;
generate one or more expected results;
transmit the processing request to a graphics processing unit (GPU);
receive processed results from the GPU; and
compare the processed results with the one or more expected results to verify the processed results.

8. The icon validation system of claim 7, wherein the icon is animated, wherein the processor is further configured to:
shuffle components of the processing request for each time frame associated with the icon;
update the one or more expected results based on the shuffling; and
validate the icon based on the one or more expected results for each frame of the icon.

9. An icon validation system comprising:
a memory configured to store a plurality of icon shapes; and
a processor communicatively coupled to a graphics processing unit (GPU) associated with a vehicle, the GPU configured to present graphics and an icon indicative of a state of the vehicle by a vehicle display, the processor configured to:
detect, by an edge detection algorithm, an icon shape of the icon when overlaid on the presented graphics on the vehicle display;
compare the detected icon shape with the plurality of stored icon shapes;
based on the comparison, validate the icon for overlay on the displayed graphics; and
present the validated icon overlaid on the graphics on the vehicle display.

10. The icon validation system of claim 9, wherein the processor is further configured to compare a background color of a background of the vehicle display with an icon color of the icon and determining an observability of the icon.

11. The icon validation system of claim 10, wherein the processor is further configured to display a safety icon overlay over the icon when the observability of the icon is below an observability threshold.

12. The icon validation system of claim 11, wherein the icon is animated.

13. The icon validation system of claim 11, wherein the background is animated.

14. The icon validation system of claim 9, wherein the processor is further configured to:
generate one or more criteria for validating the icon including a processing request;
generate one or more expected results;
transmit the processing request to the GPU;
receive processed results from the GPU; and
compare the processed results with the one or more expected results to verify the processed results.

15. The icon validation system of claim 14, wherein the icon is animated, wherein the processor is further configured to:
shuffle components of the processing request for each time frame associated with the icon;
update the one or more expected results based on the shuffling; and
validate the icon based on the one or more expected results for each frame of the icon.

16. An icon validation system comprising:
a processor configured to instruct a graphics processing unit (GPU) to present graphics and an icon indicative of a state of a vehicle by a vehicle display;
a memory communicatively coupled to the processor and configured to store a plurality of icons; and
the processor further configured to:
detect an icon shape when overlaid on the presented graphics on the vehicle display;
compare the detected icon with the plurality of stored icons;
based on the comparison, validate the icon for overlay on the displayed graphics; and
present the validated icon overlaid on the graphics on the vehicle display.

17. The icon validation system of claim 16, wherein the processor is further configured to display a safety icon overlay over the icon when the observability of the icon is below an observability threshold.

18. The icon validation system of claim 16, wherein the processor is further configured to detect the icon based on its shape using an edge detection algorithm.

19. The icon validation system of claim 16, wherein the processor is further configured to:
generate one or more criteria for validating the icon including a processing request;
generate one or more expected results;
transmit the processing request to the GPU;
receive processed results from the GPU; and
compare the processed results with the one or more expected results to verify the processed results.

20. The icon validation system of claim 19, wherein the icon is animated, wherein the processor is further configured to:
shuffle components of the processing request for each time frame associated with the icon;
update the one or more expected results based on the shuffling; and
validate the icon based on the one or more expected results for each frame of the icon.
